(19) United States
(12) Patent Application Publication
(10) Pub. No.: US 2011/0209728 A1
(43) Pub. Date: Sep. 1, 2011

(54) TEXTURED CLEANING WIPE FOR ELECTRONIC DEVICES

(76) Inventor: Nima Sharifi, West Hollywood, CA (US)

(21) Appl. No.: 13/038,381

(22) Filed: Mar. 1, 2011

Related U.S. Application Data
(63) Continuation of application No. 12/229,736, filed on Aug. 25, 2008, now abandoned.
(60) Provisional application No. 60/966,012, filed on Aug. 25, 2007.

(51) Int. Cl. B08B 1/00; A47L 25/00

(52) U.S. Cl. 134/6; 15/210.1

(57) ABSTRACT

A cleaning wipe with a plurality of stiff triangular or rectangular-cross-sectional projections rising from the surface of a non-woven cloth is designed to clean the nooks and crannies, various crevices and other hard to reach areas of cell phones or other electronic items with a myriad of buttons and/or camera lenses, charger outputs, mouthpieces, ear receivers and keypads which are designed in countless shapes and sizes. The projections, whether in the form of cones, pyramids, length-long ridges or other embodiments are specifically designed to clean the small crevices, the mouthpiece and earpiece and between small buttons such as keypads on a cell phone or other electronic device.

### CROSS-REFERENCES TO RELATED APPLICATIONS

This application is a continuation of prior U.S. application Ser. No. 12/229,736, filed Aug. 25, 2008, which claims the benefit of U.S. Provisional Application No. 60/966,012 filed Aug. 25, 2007, the entire contents of which are incorporated by reference in their entirety.

### FIELD OF THE INVENTION

This invention relates generally to cleaning wipes, and more particularly has reference to a textured cleaning wipe for cleaning cell phones or other electronic devices.

### BACKGROUND OF THE INVENTION

In the past decade cell phones have penetrated nearly 50% of the global population. It is estimated that about 4 billion people currently have a cell phone or other mobile electronic communication device such as a smartphone. Cell phone usage has also exploded during this time. As calling plans are more affordable, people are more accustomed and dependent on mobile communication, and cell phones do much more than just make calls, with many models providing web-surfing, email and gaming functions, in addition to organizer-like functions such as calendars and notepads, as well as video and image recording and playback. All this has physically resulted in a significant majority of the population, of all ages, constantly carrying around and often holding or using some type of small electronic gadget such as a cell phone, smartphone, mp3 player, digital camera, or other electronic device. These electronic devices typically have numerous buttons, slots, crevices, keys, screens and other uneven surfaces from which germs and bacteria accumulated from continuous use cannot be easily reached and cleaned with an ordinary wipe or cloth.

As a result, some scientists and microbiologists have concluded through lab tests and other studies that an average cell phone may be dirtier than a toilet seat. Even without these scientific studies, it is common sense that cell phones accumulate and harbor germs from constant use with hands, and from being pressed against the side of the face during a phone call. Women for example, suffer especially because they often get makeup on their cell phones. A need exists for a consumer cleaning article that will effectively clean the hard to reach spaces on various cell phone devices and other electronics such as game controllers, computer mice, mp3 players, etc. The present invention satisfies that need.

### SUMMARY OF THE INVENTION

The present invention relates to cleaning wipes for electronic devices made from non-woven fabrics having a textured surface on one or both sides and their use as a wipe to clean and/or disinfect surfaces and crevices of electronic devices such as cell phones, keyboards, and digital cameras. In one embodiment, a cleaner and/or disinfectant solution is absorbed into the fabric. In another embodiment the cloth will have a plurality of projections that will extend across one length of the cloth without breakage. In another embodiment a plurality of projections will have triangular cross-sections and in another embodiment, a plurality of projections will have rectangular cross-sections. In one embodiment a plurality projections will be in form of pyramids, with breakage horizontally and vertically across the length and width of the cloth and will have triangular cross sections.

### BRIEF DESCRIPTION OF THE DRAWINGS

FIG. 1 is a simplified plan view illustration of a cleaning wipe embodying the novel features of the present invention, and showing a pattern of cone-shaped projections rising from the surface of a non-woven fabric.

FIG. 2 is a side elevational view of the cleaning wipe shown in FIG. 1.

FIG. 3 is an enlarged, fragmentary, cross-sectional view, taken substantially along the line 3-3, of FIG. 1.

FIG. 4 is a simplified perspective view illustration of an alternative embodiment of the invention, showing a pattern of long triangular ridges extending across the surface of a non-woven fabric.

FIG. 5 is a simplified plain view illustration of yet another embodiment of the invention, showing a zig zag pattern of ridges extending across the surface of a non-woven fabric.

FIG. 6 is a simplified plan view illustration of yet another embodiment of the invention, showing a pattern of undulating ridges extending across the surface of a non-woven fabric.

FIG. 7 is a simplified plan view illustration of yet another embodiment of the invention, showing a pattern of pyramid-shaped projections rising from the surface of a non-woven fabric.

FIG. 8 is a perspective view of the wipe shown in FIG. 7.

FIG. 9 is a simplified plan view illustration of yet another embodiment of the invention, showing another pattern of long triangular ridges extending across the surface of a non-woven fabric.

FIG. 10 is a perspective view of the wipe shown in FIG. 9.

FIG. 11 is a cross-sectional view, taken substantially along the line 11-11, of FIG. 9.

FIG. 12 is a fragmentary, side elevational view of a roller die used to form projections on the surface of a cleaning wipe of the present invention.

FIG. 13 is an enlarged, fragmentary view of another embodiment of the invention, showing a cross-sectional view of long rectangular ridges extending across the surface of a non-woven fabric.

### DETAILED DESCRIPTION OF THE INVENTION

The present invention relates to a cleaning wipe for electronic devices made up of a non-woven fabric having a textured surface on one or both sides of the baric especially designed to clean and disinfect the surfaces of electronic devices such as cell phones, keyboards, and digital cameras.

1. DEFINITIONS

The following terms are utilized throughout this application:

Projection or texture refer to any raised or lowered portions of a fabric with respect to the horizontal plane of the fabric. Thus, the term “projection” or “texture” includes, without limitation, a raised or depressed portion of the fabric that is surrounded by flat areas of the fabric (hereinafter “isolated projection”) and long continuous raised or depressed portions of the fabric that runs across the surface of the fabric (hereinafter “ridge”).

Triangular refers to a shape that resembles a geometric two-dimensional triangle. Triangular may cover shapes that do not have perfectly angled tips or flat surfaces of a triangle. The term triangular may include, without limitation, shapes which are wide at the base but narrows when approaching the apex.

Triangular cross section refers to the resultant triangular shape of a cross section through the middle of a projection.

Rectangular refers to a shape that resembles a geometric two-dimensional rectangle. Rectangular may cover shapes that do not have perfectly angled corners or flat surfaces of a rectangle. Rectangular may include, without limitation, shapes which are wide at the base and similarly wide at the top.

Rectangular Cross section refers to the resultant rectangular shape of a cross section through the middle of a projection.

The invention of the present application may be described by, but not necessarily limited to, the exemplary embodiments provided.

As is shown in the drawings for purposes of illustration, the invention embodies a textured cleaning wipe specially adapted for cleaning cell phones or other electronic devices. Preferably, the wipe is made of non-woven fabric that has projections on the surface of the fabric. In another embodiment, projections have a triangular or rectangular cross section.

A desirable feature of projections having a triangular cross-sectional shape is that they are adapted to effectively clean crevices and other small areas on the surface of electronic devices. The variable width from the base to the apex of a projection with a triangular cross section provides greater surface area to contact crevices and other small areas on the surface of electronic devices. This configuration allows projections to reach a plurality of hard to reach spaces on the surfaces of key pads, cell phones, or other electronic device. Projections with a triangular cross-sectional shape include, but are not limited to, conical projections, pyramidal projections, and ridges with a triangular cross section.

In a preferred embodiment, the projections have a triangular cross section as best shown in FIGS. 2-3. The projections 2 rise from the surface 4 of a non-woven fabric 6 and have a triangular cross-section with a pointed tip 8 and wider base 10, no matter what shape or pattern they create on the surface of the wipe (i.e. zig-zags, straight lines, S-curves, etc.)

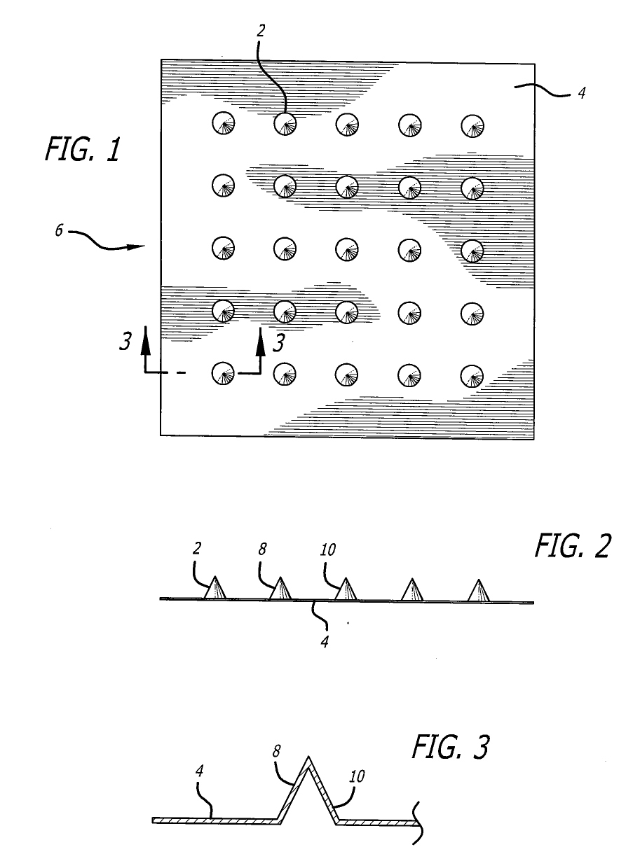

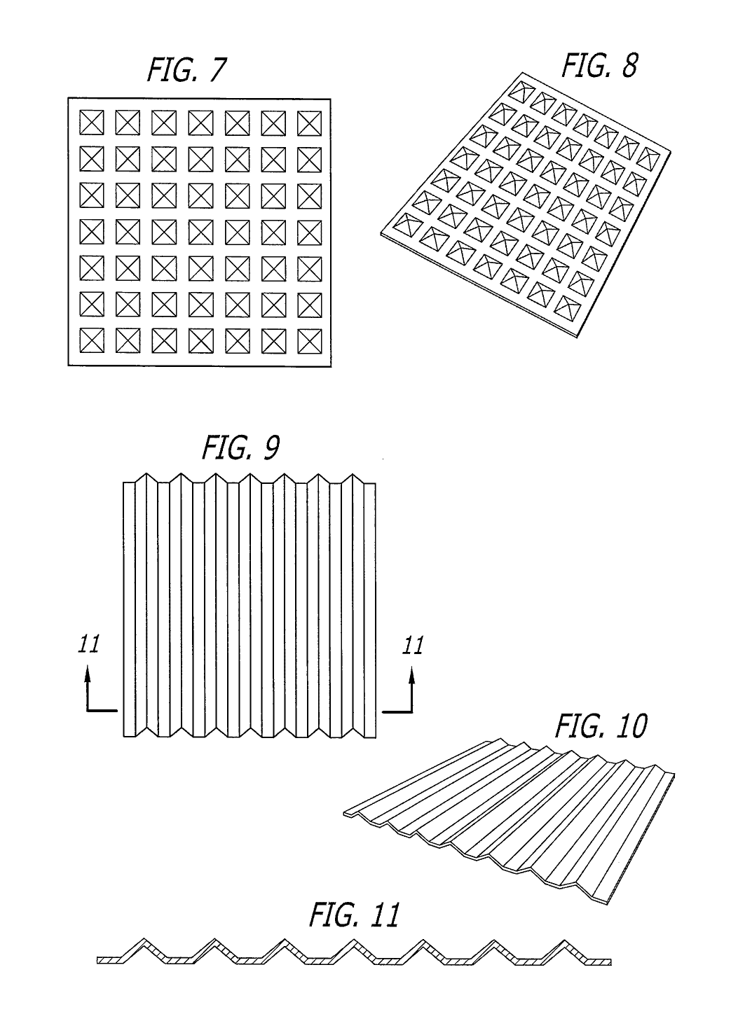

Specific examples of suitable textures include an array of cones (FIGS. 1-3) or pyramid-shaped projections (FIGS. 7-8) arranged on the surface of the wipe in a series of rows and columns which forms a rectangular grid pattern, with each cone or projection being spaced from the adjacent cone or projection and being surrounded by flat areas of the surface.

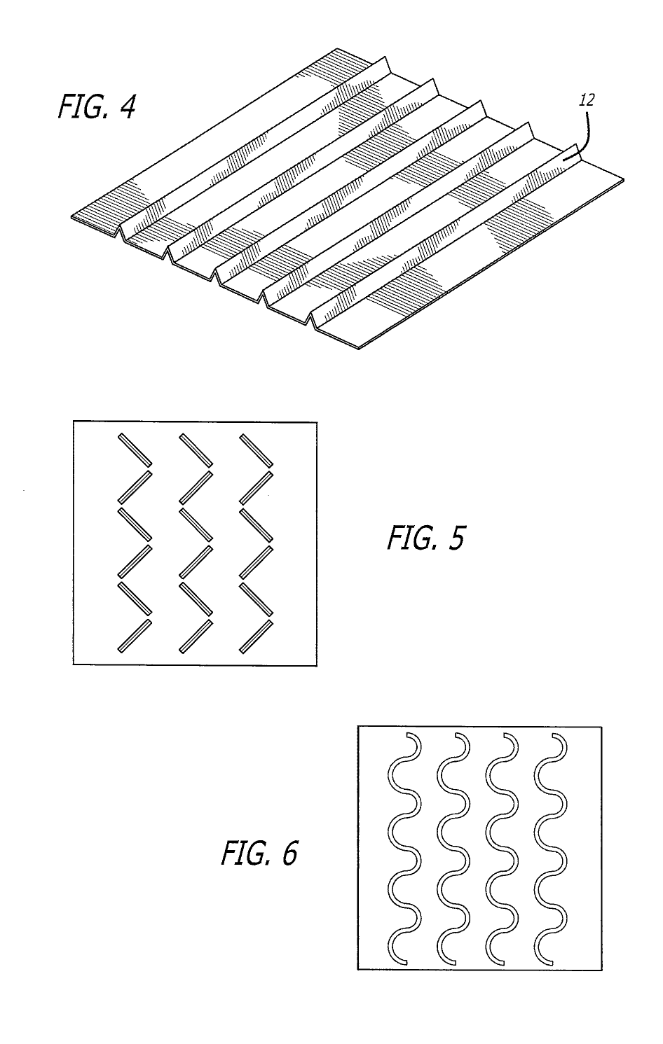

Alternatively, the projections can be provided as a series of spaced-apart elongated ridges (FIGS. 4-6) which run parallel to each other and extend across the surface of the wipe. The ridges can be straight (FIG. 4), curved (FIG. 6), or have a zigzag pattern (FIG. 5). Preferably, each projection is relatively wide in cross-section as compared to its height.

The projections can be hollow (as shown), or more preferably, solid and filled with the same fabric material as the underlying substrate.

These projections with triangular cross sections can have a variety of different sizes and shapes. For example, the projections can have the shape of pyramids or cones, with square or round bases, respectively. The heights can vary from about 0.2-5.0 mm, and more preferably 0.5-2.5 mm. In a typical example, the bases (or diameters for cones) will be about 3 mm wide, and spaced about 2-4 mm apart horizontally and vertically across the surface of the non-woven fabric in a rectangular or non-rectangular grid pattern of discrete, spaced-apart projections.

Other embodiments feature long triangular ridges 12 or continuous elevations that run one length of the non-woven fabric, as best shown in FIG. 4. One embodiment of the present invention involves utilizing triangular ridge projections between 0.5-2.5 mm in height, with a base width of about 1.0-5.0 mm spaced preferably 1.0-5.0 mm apart and having a length which is equal or substantially equal to the length of the fabric.

Other embodiments feature long rectangular ridges, 15 or continuous elevations that run one length of the non-woven fabric, as shown in a cross-sectional view in FIG. 13. One embodiment of the present invention involves utilizing rectangular ridge projections between 0.3-2.5 mm in height, with a base width of about 1.0-5.0 mm spaced preferably 1.0-5.0 mm apart and having length which is equal or substantially equal to the length of the fabric.

Yet other embodiments modify the above ridges design by introducing vertical spaces or separations along the length-long ridges, resulting in a pattern such as the pyramid design described above, or the zig-zag pattern shown in FIG. 5.

Yet other embodiments feature ridges that run across the wipe in zig-zag patterns (FIG. 5), or S-shaped patterns (FIG. 6). These produce a randomized cleaning angle, which is good for cleaning surfaces with a variety of differing sizes and shapes of crevices. Still other embodiments (not shown) feature ridges representing a mark or other figure or image, while maintaining the disclosed triangular or rectangular cross-section.

The non-woven fabric may be formed from a variety of different fiber blends and compositions. 100% split microfiber, 20-80% Polyester and 80-20% Nylon is presently preferred.

Alternatively, the fiber composition may consist of Eighty Percent (80%) Polyester and Twenty Percent (20%) Nylon. Additional, either Polyester or Nylon may be replaced with Rayon or other synthetic fiber or natural fiber. Other embodiments may be 25-95% split microfiber and 75-5% combination of synthetic or natural fibers less than 1 denier but preferably not split-able and not bi-combinant fibers. A particular fiber blend suitable for use with the present invention is One-Hundred and Fifty (150) gram fabric, 50% split microfiber (80/20% polyester/nylon blend) and 50% viscose (which gives it better body, folding ability and moisture absorption/release). Preferably, the resulting fabric is scratch-free. Examples of other fiber blends for the present invention include Microfiber 16 segmented PIR shaped rolls of fabric with central round core, star-like projections and triangular segments between each star shaped projection. In one embodiment of the present invention such fabric shall contain a Polyester core where triangles in between are Nylon, can be made with Nylon Core and protuberances and Polyester triangular segments in between. One method uses the bicombinant, drawn yarn; drawn through spinnerets however making the product with staple can be done and used if desired. Staple fiber is when the filament fiber is cut into pieces, then spun, drawn or by other method, made into a finished yarn which is then made into the non-woven substrate.

It is desirable for the projections to be sufficiently stiff or firm to resist axial compression when subjected to the range of pressures typically exerted by a person wiping a surface with a cloth. Various production methods can be used for making the non-woven fabric and the stiff projections with triangular or rectangular cross sections on the surface of the fabric.

The surface texturing can be formed in a variety of different ways, including calendaring, embossing, or embroidering, from a single piece of material. Alternatively, if desired, the projections can be formed separately from the same or different material, and attached to the wipe by adhesive or other suitable bonding methods.

For example, the non-woven webs may be created using a number of production methods common in the trade, including without limitation, needlepunch, spunlace, hydrojet or lattice methods.

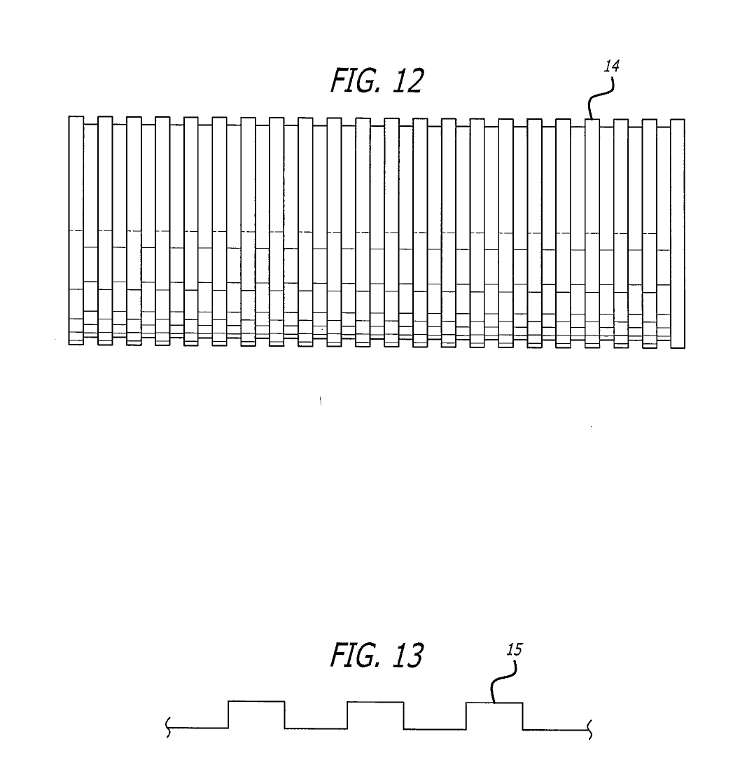

The triangular or rectangular (FIG. 13) ridges, cones or other projections created can be made using a heat roller with die on one or both sides and the fabric passing through the custom die(s) where with pressure and heat the projections are formed into the non-woven fabric. Examples of suitable devices include a metal, ultrasonic heated roller die 14 (FIG. 12) or a hard rubber roller die with electrical coils (non shown).

A variety of different methods can be used to keep the projections firm. Thus, for example, in a production method using die, heat and pressure to create the triangular projections, the heat and pressure are also used to cause the projections created and its surrounding fabric to be pressed down, compressed using, for example, 10-1000 psi and heat of 100-225 degrees F., depending upon the fiber materials being used. The firmness also can be affected by the weight of the base fabric (e.g., 50 grams/square meter) and the fiber blend (e.g., 50% polyester/50% viscose).

In some embodiments of the present invention, a liquid solution is absorbed into the wipe. Dry fabrics generally do not remove oil and germs effectively.

In some embodiments of the present invention, a cleaning or disinfecting solution is absorbed into the wipe. Some cleaning or disinfecting solutions to be absorbed into a non-woven fabric include, but are not limited to, ethyl alcohol, Benzethonium Chloride, Alkyl, and Dimethyl Benzyl Ammonium Chloride. A variety of different cleaning or disinfecting solutions can be used. One cleaning solution is a quick-drying, alcohol-based cleaning solution to minimize the potential hazard of shorting electronic equipment. A calibrated amount of solution is used to moisten but not over saturate the non-woven fabric to minimize the potential hazard of shorting electronic equipment, while still providing effective cleaning power. Thus, for example, in at least one embodiment, the wipes are impregnated with approximately 1.5 g of liquid solution, but this amount can be affected by the size of the fabric (here, 4″×4″) and by the composition of the fabric and its absorbency (here, 50% viscose, 50% microfiber).

The wipes of the present invention can be packaged in a variety of different ways. In one embodiment, cell phone wipes will be packaged and sealed individually, allowing the users to remove one wipe from the box and take with him or her throughout the day, unwrapping and using the moist wipe when needed. Cell phone wipes are a mobile solution for a mobile device, cell phones. Thus, a tub-like dispenser or other multi-pack solutions are generally impractical because the busy cell phone user is not going to carry ten moist wipes with him or her. Single packaging allows users to take just one wipe with them on the road and use when needed, providing a more practical solution. Ideally, the wipes will be made compact (small) and convenient (disposable) so that they can travel with the device they are intended to clean. A typical size for a cell phone wipe is a rectangular sheet about 4″×4″ to 5″×5″.

While several particular forms of the invention have been illustrated and described, it will be apparent that various modifications can be made without departing from the spirit and scope of the invention.

What is claimed:

1. A textured non-woven cleaning wipe for electronic devices comprising:
(a) a non-woven fabric made from synthetic, natural fibers, or blends thereof;
(b) a plurality of projections rising from a surface of said fabric, wherein said projections have triangular or rectangular cross sections and are sufficiently firm to resist axial compression during a cleaning action.

2. The cleaning wipe of claim 1 wherein projections on the surface of the fabric have a height between 0.2-5 mm and a base of about 3 mm.

3. The cleaning wipe of claim 1 wherein each of the plurality of projections has a pyramidal shape

4. The cleaning wipe of claim 1 wherein each of the plurality of projections has a conical shape.

5. The cleaning wipe of claim 1 wherein each of the plurality of projections is continuous without breakage along one length of the cloth.

6. The cleaning wipe of claim 1 wherein each of the plurality of projections has a triangular cross section.

7. The cleaning wipe of claim 1 wherein each of the plurality of projections has a rectangular cross section.

8. The cleaning wipe of claim 1 wherein each of the plurality of the rectangular projections is length long and continuous.

9. The cleaning wipe of claim 1 wherein the fabric is made up of 100% split microfiber.

10. The cleaning wipe of claim 1 wherein the fabric is made up of 20-80% polyester and 80-20% nylon.

11. The cleaning wipe of claim 1 wherein the fabric is made up of about 80% polyester and 20% nylon.

12. The cleaning wipe of claim 1 wherein a calibrated amount of a cleaning or disinfecting solution is impregnated into the fabric prior to use.

13. The cleaning wipe of claim 1 wherein the projections are arranged on the surface of the fabric in a series of rows and columns which forms a rectangular grid patter, with each projection spaced from adjacent projections.

14. The cleaning wipe of claim 1 wherein each of the plurality of projections is a ridge, and said ridges form a straight line, undulating, or S-shaped pattern across the surface of the fabric.

15. The cleaning wipe of claim 12 wherein the liquid solution has disinfectant properties.

16. The cleaning wipe of claim 1 wherein the projections are provided on both sides of the fabric.

17. The cleaning wipe of claim 1 wherein the projections are solid and filled with the same fibers as the non-woven fabric.

18. A method for cleaning electronic devices comprising the steps of wiping a surface of the electronic device with a textured non-woven fabric having a plurality of raised projections on a surface of the fabric, the projections having triangular or rectangular cross sections and being sufficiently firm to resist axial compression during the wiping action, wherein the projections reach into and clean crevices and other small areas on the surface of the electronic device during the wiping action.

19. The method of claim 18, further comprising the step of cleaning and disinfecting the surface of the electronic device with a liquid solution contained in the fabric during the wiping action.
